(19) United States
(12) Patent Application Publication
(10) Pub. No.: US 2012/0101953 A1
(43) Pub. Date: Apr. 26, 2012

(54) SYSTEM FOR ACCELERATING OCCUPATIONAL SAFETY AND HEALTH ADMINISTRATION (OSHA) COMPLIANCE FOR THE MANAGEMENT OF PROCESS SAFETY IN A MANUFACTURING FACILITY

(75) Inventors: Nigel Denis James, Lake Jackson, TX (US); Robert Gregory Geter, JR., Lake Jackson, TX (US)

(73) Assignee: MANGAN, INC., Lake Jackson, TX (US)

(21) Appl. No.: 12/912,542

(22) Filed: Oct. 26, 2010

(51) Int. Cl. G06Q 10/00

(52) U.S. Cl. 705/317

(57) ABSTRACT

A system for a computer implement process for accelerating and validating OSHA compliance for a safety systems lifecycle management to achieve functional safety at a facility as required in a hazard and risk assessment for the facility by providing monitoring, tracking of remediation, validation of remediation and reporting for auditing requirements, all steps related to achieving compliance.

### FIELD

The present embodiments generally relate to a system for tracking compliance, ensuring compliance, accelerating compliance, and validating compliance with OSHA regulations and rules.

### BACKGROUND

Significant changes to corporate governance and accountability occurred with the approval of the United States Occupational Safety and Health Assessment (OSHA) rule known as 29 CFR 1910.119 with an effective date of Mar. 7, 1996.

The OSHA rule was interpreted and standardized into an industry known standard identified as American National Standard ANSI/ISA-84.00.01-2004 Part 1 (IEC 61511-1 Mod, also referred to herein as ANSI/ISA 84) for the functional safety of safety instrumented systems for the process industry as approved on Sep. 2, 2004.

The standard was created for the purpose of improving the accuracy, integrity, and reliability of corporate compliance with health and safety rules of the United States using safety instrumented systems.

OSHA requires use of recognized and generally accepted good engineering practices (“RAGAGEP”) in pressure relieve devices and system under 29 CFR 1910.119(D)(3)(ii). GAGAGEP includes good engineering operational and maintenance activities based on established codes, standards, and best practices.

The ANSI/ISA 84 provides protection to workers and to the environment by mandating a set of internal procedures regarding corporate accountability, audit requirements, and compliance.

THE ANSI/ISA 84 standard covers such issues as establishing a plan for layers of protection for instrumented systems, a “layer of protection analysis” (LOPA) and auditing of these systems to ensure greater corporate responsibility.

OSHA creates an obligation for officers and directors of a company to warrant multiple parties, not limited to government officials, and state the stages of compliance and the accuracy of the company's audit of its compliance, and provide a reporting on the internal controls in place to safeguard the employees and others working at a company that qualifies for hazard and risk assessment.

Significantly enhanced penalties for the more serious corporate crimes, in response to the United States OSHA Rule 29 CFR 1910.119 rule have been put in place since the BP oil spill disaster in the Gulf of Mexico and other recent disasters. Such rule changes cause owners to install higher levels of compliance for the safety instrumented and non-instrumented systems of facilities that require hazard and risk assessments from OSHA.

For example, OSHA Docket numbers 09-1695 and 09-1787 have a stipulation against BP Products North America, for an explosion in Texas City, Tex. in 2005. The stipulation assessed a 50 million dollar fine against BP Products North America and required the implementation of ANSI/ISA-84 and RAGAGEP by BP Products North America.

The ANSI/ISA-84.00.01 provides a framework for establishing internal controls for regulating accountability, governance, and compliance with regard to the OSHA rule, namely, Risk Assessment, Control Environment, Control Activities, Information and Communications, and Monitoring. Although compliance with the 29 CFR 1910.119 serves to mitigate problems with compliance, companies need to ensure their compliance faster, more quickly, with reliable accountability to stockholders and investors, which can lead to increased stock valuation and improved overall company value.

Compliance with 29 CFR 1910.119, the OSHA Rule, in view of the 100+ days of the BP oil spill in the Gulf of Mexico, is accordingly an urgent issue for many public companies, particularly the companies that lack knowledge of how to quickly and accurately acquire compliance information on their own processes.

Many companies simply lack the work processes for addressing the OSHA requirements and implementation of the internal controls for OSHA compliance. These companies need a system that is usable, easily, which can quickly and accurately provide compliance information on a real time basis.

A need exists for a system for accelerating the compliance process to efficiently establish OSHA compliance within a company.

A need exists for systems to establish and implement efficiently internal controls for testing and monitoring within a company to mitigate any assessed company risks and to provide improvements for company management and operations in compliance with the OSHA Rule.

The present embodiments provide a system that meets these needs.

### BRIEF DESCRIPTION OF THE DRAWINGS

The detailed description will be better understood in conjunction with the accompanying drawings as follows:

FIG. 1 is a diagram of the information flow usable in the system.

FIG. 2 is a diagram of an embodiment of the equipment and network usable with the system.

FIGS. 3A-3B depict the computer instructions in the data storage of the system.

FIG. 4 is a real time dashboard according to the system.

FIG. 5 is a detail of an indicator showing compliance, non-compliance and indeterminate compliance for a particular system.

The present embodiments are detailed below with reference to the listed Figures.

### DETAILED DESCRIPTION OF THE EMBODIMENTS

The present embodiments generally relate to a system for tracking, ensuring, accelerating, and validating compliance with OSHA regulations and rules for a manufacturing facility.

The present system can include a database, also referred to herein as the “central database” that can be easily searchable when compared to traditional systems used for maintaining compliance data.

The system provides a drill down ad hoc query system that can use 4 additional databases connected via the network to easily locate information on compliance and present that information to a plurality of users simultaneously using real time dashboards that can be viewed on a cell phone, an iBook with connectivity, or another mobile device for fast reactivity by management to a potential problem.

A benefit of the present system it that the cost of training for monitoring safety compliance can be minimized.

Another benefit of the present system is to provide to a facility, a lower maintenance cost for safety compliance than traditional compliance remediation and tracking methods.

The system allows a facility to achieve compliance for a lower cost as the system can be maintained with fewer people and quickly, to complete the same amount of effort.

The system can provide for fewer errors than are inherent in maintaining multiple database compliance systems or disconnected data storages, resulting in more accurate compliance information.

Still another benefit of the system is that the system incurs fewer errors than the non-centralized systems by using the centralized database.

A benefit of the current system is that with the centralized database, fewer mistakes occur from using disconnected data storage to achieve compliance of a manufacturing plant, such as a chemical plant, or a car assembly plant.

The anticipated results from this system is that move accurate compliance records are kept, with at least 20% higher accuracy than disconnected database entry and re-entry techniques.

Yet another benefit is that the system allows a user to quickly retrieve information regarding the safety method for compliance audits in only a few minutes, such as 60 to 120 minutes rather than a few hours, for faster remediation, faster reaction time to save the lives of endangered people and faster reaction time to save the environment and prevent environmental hazards.

The accelerated compliance system can be used in real time, to provide results to multiple users in less than a few hours, such as 120 minutes or in less than 1 hour, on the status of compliance for a facility that requires a hazard and risk assessment, such as an oil rig in the Gulf of Mexico.

The system enables management to quickly view and act on process safety issues in a facility without the need for complete and total technical safety expertise. The use of a novel red traffic light indicator for stop or “out of compliance”, the use of a novel green traffic light indicator for go or “in compliance” the use the user of a special yellow traffic light indicator by equipment, process or facility to indicate to a user of “indeterminate” compliance and readily indicate to a manager or non-technical person the status of the facility, or the status of a process, of the status of a piece of equipment.

The inventive system can function as a repository of key information for validating, tracking and providing compliance with OSHA Rules to lower the potential for fines to a facility. The system can be an effective “insurance management” tool, helping lower the cost of insurance premiums on a facility.

The system can be used by management to validate the use of protection layers. The term “IPL” is used here to refer to independent protective layers. Having multiple IPLs in place in a facility helps to avoid fines from OSHA associated with noncompliance of OSHA regulations and rules that require the use of IPLs.

The system provides to a plurality of users simultaneously through a plurality of gateway protocols simultaneously, a real time dashboard, which is also referred to herein as “an executive dashboard” or a “real time executive dashboard” or variations of these terms.

The system enables the real time dashboard to be viewed at a plurality of locations on a plurality of client devices simultaneously.

The real time dashboard on a cell phone and laptop simultaneously can show the status of compliance as well as the rate at which compliance is occurring for independent pieces of equipment, software, and/or processes in a facility, or for an entire facility.

The system includes a centralized data storage of independent protection layers (IPLs) which can include a central dynamic information database.

The central dynamic information database (one of the plurality of databases used herein simultaneously), or the “central database “as it is also referred to herein, can be updated from a client device or from a safety instrumented system device, such as a transducer, a meter, or another tracking device at regular intervals, such as every week or every month, to provide the most current information on the independent protections layers for a management user.

The database of centralized IPL information is used in the system to collect instrumented safety related components and non-instrumented safety related components from the IPLs extracted from the layer of protection analysis (LOPA) of the facility.

One or more embodiments relate to a system for accelerating and validating OSHA compliance for a safety system lifecycle management to achieve functional safety at a facility as required in a hazard and risk assessment for the facility, and in compliance with Occupational Safety and Health Assessment rule 29 CFR 1910.119 with an effective date of Mar. 7, 1996.

The system can provide monitoring, tracking of remediation, validation of remediation, and reporting for auditing requirements on individual safety related components in the facility or in a portion of the facility, or in portions of groups of related facilities.

For example, the monitoring performed by the system can be performed by analyzing a designated number of IPLs, determining a percentage of compliance for the designated number of IPLs, tracking remediation using a checklist of tasks to review and validate key documentation requirements.

As an example, the system can be used to validate remediation by comparing actual data to design data and other assurance activities, such as functional safety assessments (FSA).

The reporting for auditing requirements can be handled by the system using email over the network, or by printing independent protection layer (IPL) lists, printing or emailing validation failure lists, or by printing or emailing percentages of compliant independent protection layers.

The system can include a processor, such as an Amazon machine image hosted remotely, wherein the processor is made by Dell Corporation of the US and the processor communicates with a data storage.

The processor and the data storage can be in communication with client devices, other data storage, and other equipment through a network.

The system can include more than one processor. In an embodiment, multiple processors can be synchronously connected together.

In embodiments, the processor with the data storage can be a web server connected to another data storage over the network.

The processor can be within the web server, connected to at least one network, a server maintained by a service provider, or a client device connected to the network.

The data storage can be in communication with the processor and remote from the processor, or the data storage can be a jump drive that attaches directly to the processor.

The network can be a satellite network, a cellular network, the Internet, a local area network, another IP packet delivery system, or combinations thereof.

The system can be used over multiple different networks connected together.

At least one client device can be connected to or in communication with the network. The client device can be a cell phone, a laptop, an iPad™, an iPod™ with connectivity to a network, an iBook™ with connectivity to a network, an iPhone™, a desktop computer, a processor with a web browser, or combinations thereof.

Each client device can access a plurality of computer instructions in the data storage through the network using, for example, a secure login and password.

In an embodiment, each client device can additionally have a downloadable application to access the data storage and processor.

The system can have computer instructions for use with mobile devices, allowing a mobile device to have faster connectivity to the processor and the data storage and allowing for viewing of the real time dashboard that accelerates the compliance by a facility or portions of a facility.

The system uses computer instructions in the data storage to extract independent protective layers (IPL) from a layer of protection analysis (LOPA) for at least a portion of a facility. The layer of protection analysis has resulted from a hazard and risk assessment for at least a portion of the facility.

The system uses computer instructions in the data storage to form a protected, secure, encrypted and limited access database of centralized identified protection layer information.

The protected, secure, encrypted, and limited access database of centralized identified protection layers is also termed herein an independent protection layer registry (IPL REGISTRY).

The IPL Registry can have a variety of levels of information, most of which can not be modified by a user of the IPL Registry, only by an administrator of the system.

The IPL Registry has extracted independent protection layers, multiple layers of security, wherein each layer of secury has a unique access priority code for controlled management of the IPL Registration.

In the IPL Registry, one or more of the independent protection layers can include identifiers for one or more pieces of equipment, software, processes, or combinations thereof, or an entire facility. These pieces of equipment, software and processes are the ones in the facility or portion of the facility that reduce a risk of a hazard identified in the hazard and risk assessment, by controlling, preventing, or mitigating the risk of an identified hazard.

At least one IPL of the IPL Registry can include a list of instrumented safety related components for at least of portion of the facility.

For each instrumented safety related component, the IPL registry can have an automated action for a safety instrumented control system that performs an automatic shut down of a piece of equipment, a process, or the facility. For example, the automated action can be an automatic shut down of a Triconex™ (triple modular redundant—TMR) on a fired heater.

At least one IPL of the IPL Registry can include a basic mechanical device, which can include a mechanical stop on a piece of equipment. For example, the independent protection layer can be a mechanical stop on a valve to prevent the valve from closing completely during a loss of instrument air failure.

At least one IPL of the IPL Registry can include can include a process alarm for an instrumented device that provides a notification by email, text, visual signal, audio signal, or combinations thereof, to an operator for intervention in a prescribed time period, such as within 20 minutes.

At least one IPL of the IPL Registry can include can include a basic process control system (BPCS) that can be a level control, a temperature control, a pressure control, a high level safety interlock or a combination of these types of control processes.

The IPL Registry can include computer instructions to extract independent protection layers from the LOPA and computer instructions to create multiple layers of security. Each layer of security preventing non-authorized users from accessing highly sensitive areas of the IPL Registry.

The IPL Registry can be store information on not only instrumented safety related components for at least a portion of the facility as described above, but also non-instrumented safety related components for at least a portion of the facility, or combinations thereof.

Turning now to the concept of LOPA, this concept, as the term LOPA is used herein refers to a simplified risk assessment for at least a portion of a facility.

A LOPA enables the evaluation of risks of hazard scenarios and the comparison of the evaluation of those risks with risk tolerance criteria to decide if existing safeguards are adequate for the facility to meet OSHA compliance.

The LOPA enables a user of the system to additionally determine if and when additional safeguards need to be analyzed and used in a facility. A LOPA can be viewed as an extension of a Process Hazard Analysis (PHA).

A LOPA can be formed using a hazard and risk assessment for at least a portion of a facility, such as a portion of an ethylene glycol manufacturing line in a chemical plant. A LOPA can be formed for an entire facility with multiple lines of different products, such as the Lyondell Basell Chemical Plant in Houston, Tex. which makes Olefins including polypropylene and polyolefin-propylene oxide.

The instrumented and non-instrumented safety related components operating and specification information can be collected in the central database for use in the LOPA.

An example of a instrumented safety related component can be a high level deviation alarm or a check valve and in come cases, combinations of these types of components, for least a portion of the facility, for an entire facility, or for combinations of related facilities, such as two polymer units that both make polypropylene in a facility that also makes other chemical intermediates.

The system can include computer instructions stored in the data storage for forming a database of safety related design data for instrumented and non-instrumented safety related components of the facility.

Examples of safety related design data include design parameters for each piece of equipment, process, software or combinations thereof for at least a portion of the facility. It should be noted that the design parameters must meet at least one of the extracted independent protective layers required for OSHA compliance for functional safety.

For example, safety related design data may include a design of an alarm limit for a first high temperature alarm and a second high temperature shut down with a shut down set point above the first high temperature alarm, and a design of a test frequency for a critical alarm.

The database of safety related component design data can also include parameters for functional safety of the extracted independent protection layers such as a process safety time, such as ten minutes for a liquid process overfill that is set as a first level critical alarm.

The database of safety related design data can include (i) components of a safety requirement specification (SRS), such as safety integrity level calculations which can be a one, two, or three for a fired heater in a cat cracker of a refinery.

The database of safety related design data can include (ii) a description of all safety instrumented functions, such as loss of fire eye; over pressure of a fuel gas for the fired heater.

The database of safety related design data can include: (iii) a definition of a safe state for selected pieces of equipment, such as the safe state related to closing of the fuel gas system for the fired heater.

The database of safety related design data can include: (iv) a definition of a safe state for a piece of software, such as “ . . . run for the control software that operates the fired heater”.

The database of safety related design data can include (v) a definition of a safe state for a facility, such as the state wherein “ . . . all fired heaters are running and no critical alarms are activated”.

The database of safety related design data can include: (vi) requirements for proof test intervals for one or more pieces of equipment, software, facilities, or combinations thereof, such as a requirement to perform annual testing.

The database of safety related design data can include: (vi) a response time requirement to bring the process to the safe state for the piece of equipment, software, facility, or combinations thereof.

The database of safety related design data can also include: (vii) descriptions of process measurements and trip points. These descriptions could include a high temperature interlock for a fired heater or a required temperature integrity limit for the mechanical design of the fired heater.

The database of safety related design data can include: (xviii) a logic solver type for a piece of equipment, software, facility, or combinations thereof. The logic solver can be used to provide a percentage of availability or reliability, of the fired heater.

The database of safety related design data can include redundancy information, for example, that the logic solver is triple redundant, dual redundant, or simplex.

The database of safety related design data can include (x) information on each piece of a programmable electronic system for control, protection, or monitoring of other equipment, of a process, of another facility, or combinations thereof. For example, the information on the programmable electronic system for control, protection, or monitoring can be information on a programmable logic controller (PLC), such information on an Allen Bradley™ controller.

The system can include computer instructions to gather operational data for each safety related components of the facility is in the database.

For example, the computer instructions can instruct that a database system, such as Loveland, SPI, or SAP system must include records indicating that proper testing has been completed for safety related components in the facility and those records have been transmitted to the central database.

The operational data can be data from at least one original equipment manufacture

(OEM), such as data from a temperature transmitter made by Rosemond™ 644 temperature transmitter from Minnesota.

The operational data can be from an operations database for the facility, such as an INTOOL™ SPI database.

The operational data can be data from a testing facility, such as Loveland (Document).

The operational data can be data from an enterprise server, such as an SAP/PM or from combinations of these sources of data, and can include data from a linked website via a network, or data from a linked database via a network.

The operational data can include instrument equipment design, such as set points and alarm points; operation and maintenance data including maintenance records; test records; equipment specifications; equipment configurations; software configurations; equipment information; and software information.

The system can include computer instructions forming at least one checklist of tasks for a plurality of users. Each checklist of tasks is assigned to at least one component of an independent protection layer in the IPL Registry.

The checklist tasks has at least one entry to verify that the safety related components are in OSHA compliance for functional safety, thereby accelerating validation by at least 10 percent and achieving compliance systematically with real time validation using the executive dashboards with traffic light indicators.

Each task on the checklist has at least one entry that provides an instruction for an action necessary to place each safety related component into OSHA compliance for functional safety.

At least one of the task list entries verifies that a safety related component is in OSHA compliance.

This database for forming the checklist of tasks can also include computer instructions to automatically verify to accelerate validation of the compliance for each component, thereby reducing the amount of time needed to achieve compliance on a component by component basis at least 2% and up to 10% in number of minutes needed to achieve compliance.

The following is an example of how the checklist of tasks can be formed for a specific safety instrument system (SIS), such as an alkyl reactor in a facility.

Computer instructions in the data storage would look at industry standards, such as the ANSI/ISA 84, and make a checklist of tasks for an operator that are required to satisfy functional safety assessments based off of the ANSI/ISA 84.

The checklist of tasks can include a specific purpose. For example, an alkyl reactor checklist of tasks for each safety related event can include a specific purpose, such as a comparison between hazards of a Safety Requirement Specification (SRS) to hazards of a layer of protection analysis (LOPA) for the alkyl reactor.

The computer instructions to form the checklist of tasks can include computer instructions to assess independency between identified protection layers. For example, in the alkyl reactor checklist of tasks, a reactor high temperature interlock can be noted as independent of any other protective layers for the alky reactor using these computer instructions.

The computer instructions to form the checklist of tasks can include computer instructions to indicate diversity between the protection layers. For example, these computer instructions can be used for the alkyl reactor to identify and confirm that different types of temperature devices with two different technologies from two different manufacturers were used to provided diversity between those independent protection layers.

The computer instructions to form the checklist of tasks can include computer instructions to provide an indication of physical separation between different protection layers. For example, the computer instructions could be used to identify that two different instrument tap locations, each having a different temperature sensor and transmitter exist providing physical separation for these safety devices in the alkyl reactor.

The computer instructions to form the checklist of tasks can include computer instructions to identify any common cause failure between the identified protection layers.

For example, the computer instructions could be used for the alkyl reactor to identify plugged sample taps.

The computer instructions to form the checklist of tasks can include computer instructions for identifying a common cause failure between the identified independent protection layers and a basic process control system (BPCS). For example, the computer instructions could be used to identify and indicate that the same logic solver is used for two different alarms for the same process (SRA and BPCS).

The computer instructions to create the checklist of tasks include a plurality of tasks, such as the tasks to (a) verify operator training on equipment, software, processes, or combinations thereof; (b) verify availability of test procedures on operations of equipment, software, processes, or combinations thereof; (c) verify scheduled testing has been performed on operations of equipment, software, processes, or combinations thereof; (d) verify equipment, software, processes, or combinations thereof are configured to identify a fail limit; (e) verify equipment, software, processes, or combinations thereof are configured to have set alarms when the equipment, software, processes, or combinations thereof exceed a fail limit; and (f) verify an identity for each piece of equipment, software, process, and combinations thereof, as “fail-safe” or not “fail-safe”.

The results of these verifications can be presented to a user or a viewer on an executive real time dashboard showing compliance using traffic light indicators.

The traffic light indicators can be colored as green for compliance, red for non-compliance and yellow for indeterminate as a status for each verified piece of equipment, software, process, test procedure, operator training, other task, or combinations thereof from the checklist of tasks. As such, the system can provide for exceptionally fast recognition, in between 3 and 8 seconds of compliance or a non-compliance status for entire systems. Instantaneous data can be produced upon a user indicating a need or can be generated when a user sets up an automatic query.

The system can include computer instructions that compare, in real-time, without a delay of more than a few minutes, such as 60 to 120 minutes that the operational data for each of the safety related components of the facility to the IPL requirements in order to validate operational compliance.

The computer instructions compare in real time the safety related design data to the operational data for each of the safety related components to the IPL of the facility to validate operational compliance of the safety related components, and if one of the components is not in compliance, forming at least one operational finding requiring resolution.

Computer instructions in the data storage can be used to automatically indicate resolution of at least one of the operational findings.

The comparison can be a mathematical computation that reviews actual operating data from an operating unit, compares the operating data to a preset limit, and then computes a deviation from the preset limit to form at least one operational finding.

The mathematical computation can compare two values, the imported value to the design data value, each value being contained in two different tables and a cimple one line of computer code can be used to produce the computed deviation.

Each operational finding requiring a resolution which can be tracked by multiple users simultaneously.

For example, if the operational finding is that a temperature reading on one out of three temperature sensors deviates by 5% or more, then the operational finding would be to perform maintenance on the deviating transmitter and the resolution would be to recalibrate the instruments while allowing multiple user to view not only the resolutions but the recommended course of action simultaneously, such as between 20 and 50 users.

Additional computer instructions in the data storage can be used to track progress of achieved resolutions over time.

This system can be used to track the progress for achieving resolutions over units of time, for example, by first loading completed maintenance tasks, then comparing newly loaded maintenance tasks to the last time maintenance tasks were loaded and displaying the results.

The computer instructions are used to display the comparison result for the maintenance tasks to at least one viewer, and in another embodiment to multiple users simultaneously.

The data storage can also include computer instructions for allowing one or more users to indicate completion of at least one of the entries on the checklist of tasks, thereby indicating a compliance status of an independent protection layer for that entry.

The system can include computer instructions that automatically indicate resolution of at least one of the operational findings to a “viewer” of the compliance process when a user or operator inputs a change in compliance. The system can thus be a significant improvement to conventional systems that only update upon request when an operator inputs information into the database.

The system can include computer instructions to automatically indicate resolutions of at least one of the operational findings immediately upon completion of the resolution. The indicated resolutions of at least one of the operational findings can be presented on the executive dashboard when an administrator loads post resolution operational data to the centralized database. The system can include computer instructions in the data storage to compare the post resolution operational data to the safety related design data.

This system uses the critical compare feature to prevent explosions or fires in refineries by monitoring and managing safety processes in the facilities. This system will reduce the possibility of explosions that cause lost lives. This system will reduce the damage to not only the facility, but properties nearby the facility that would be damages from excursions from the facility into the atmosphere. This system allows user to keep looking at the maintenance of the system, preventing BP failures that occurred in April 2010 spilling millions of gallons of oil into the Gulf of Mexico.

The system can include computer instructions in the database to form a real-time dashboard, also termed herein an “executive dashboard”, on one or more of the client devices simultaneously showing the tasks, and pendency of resolution.

The executive dashboard can show status of completion of entries for the checklist of tasks and status of completion of resolutions of the operational findings in real-time, such as within one hundred twenty minutes of the completion and resolutions occurring.

That is, the system can automatically indicate resolution of at least one of the operational findings immediately upon completion of the resolution on the dashboard, and can also provide notice when an administrator has post resolution operational data about the equipment, process or portion of the facility.

An administrator can compare post resolution operational data to the safety related design data and form this real time executive dashboard on one or more of the client devices simultaneously allowing executives to make better decisions on plant maintenance and improving the safety of the plant and protecting nearby citizens better.

The executive dashboard can show the status of compliance for the checklist of tasks as a percent completion of the entries for the checklist of tasks.

The executive dashboard can show the status of compliance for the checklists of tasks with a rate associated with completing the entries from the checklist of tasks over time for each piece of equipment, software, process, or combinations thereof for the facility.

The executive dashboard can show a percent completion of resolutions in the operational findings.

The executive dashboard can also show a rate associated with time to complete the resolutions for each piece of equipment, software, or process of the facility.

For example, the status for a checklist of tasks with twenty entries for a facility that has only ten entries are complete, will show a fifty percent completion. The rate of completion can be shown as well as a rate such as a certain number of entries being completed per day.

The system can include computer instructions in the data storage to provide real-time reports to viewers and operators of the system for auditing compliance. The real-time reports can be transmitted to facility employees, agents, contractors, vendors, investors, environmental agencies, or combinations thereof.

The real-time reports on the real time status of OSHA compliance at the facility can be transmitted automatically at preset intervals such as by email, once a week.

These reports can be customized or standardized, and can be generated within minutes to users upon request or automatically pushed to the executive dashboards displayed on the client devices.

The customized report might include a sorted IPL report. The standardized report might be a weekly report on completed tasks or on resolutions achieved.

The real-time report can include: (i) a location of a specific instrumented independent protection layer (IPL), (ii) one or more maintenance records of a specific independent protection layer, (iii) proof that one or more functional tests on a specific independent protection layer have occurred, and (iv) additional user designated independent protection layer registry information as requested by a viewer or by a user of the system.

The system can include computer instructions in the data storage to provide at least one traffic light indicator on the executive real time dashboard to allow a viewer to visually see a real-time status of: completion of entries of the checklist of tasks, completion of resolution of operational findings, or combinations thereof.

The system can be used to accelerate and validate OSHA compliance for safety system lifecycle management to achieve functional safety at a facility as required in a hazard and risk assessment for the facility and in compliance with Occupational Safety and Health Assessment rule 29 CFR 1910.119 effective date of Mar. 7, 1996 by providing monitoring, tracking of remediation, validation of remediation and reporting for auditing requirements; all steps related to achieving compliance.

The visual traffic light indicator can be a colored alarm, an email, a text message, another visual alarm, a graphic indicator, an audio indicator, or combinations thereof.

For example, the colored alarm can be red for emergency and yellow for critical (most SIS systems have high, then high-high, then shutdown alarms).

The email or text message can read “warning: imminent shutdown about to occur”.

Besides being a colored alarm, the traffic light indicator can be a gauge, another graphical visual component showing a rate of change or a rate of completion, such as a red flashing “X” overlaid on the dashboard.

An example of another visual alarm can be a flashing light on top of an operator desk. An example of an audio alarm can be a beeping sound on a computer terminal.

The visual traffic light indicator can reveal an indication for “compliance”, such as when a process, equipment, or software that is a safety instrumented system in compliance with OSHA rules and is ready to operate. If in compliance, the light can be green.

The visual traffic light indicator can reveal an indication for “non-compliance”, such as when a process, equipment, or software that is a safety instrumented system is not in compliance with OSHA rules and is not ready to operate. If not in compliance, the light can be a red light.

The visual traffic light indicator can reveal an indication for “indeterminate”, such as when a process, equipment, or software is a safety instrumented system and not ready to operate. If at an intermediate status, the light can be yellow.

The visual traffic light indicator can be a print out or might additionally show and icon on a display screen connected to the client device which is time dated allowing a time dated status chart showing compliance entry on the checklist of tasks.

The system can also include computer instructions in the data storage for showing on the executive dashboard OSHA compliance trends by a user or viewer for designated equipment, software, processes, or combinations thereof. For example, a compliance trend for validating maintenance tasks being performed on a process unit, such as a coker slide valve in a coking facility over a defined period of days can be shown.

The system can include computer instructions to batch load operational data to the independent protection layer information of the independent protection layer registry, and to simultaneously form updated real-time reports, or within a few seconds thereof. The real-time reports can be formed automatically when the traffic light indicator depicts “non-compliance” or on a preset periodic reporting basis.

The system can include computer instructions to batch load independent protection layer data to the central database from the independent protection layer registry for forming additional real-time reports.

The system can be used in a facility that is a manufacturing facility, a chemical facility, a refinery, an offshore oil or natural gas platform, or an oil and gas pipeline.

The system can include computer instructions that indicate resolution completion and provide a date and time stamp for validating OSHA compliance on the executive dashboard.

The system can include computer instructions used with the operational finding to provide an indicator when each equipment, process, or software fails to meet a design parameters, reason for failure, corrective action, and an identifier of the software, process, or equipment.

The system can include computer instructions to present the executive dashboard for accelerated compliance on multiple client devices simultaneously in multiple formats.

The system can include computer instructions that automatically indicate resolution of at least one of the operational findings, including instructions that immediately show completion of the resolution on the executive dashboard when an administrator loads post resolution operational data and compares the post resolution operational data to the safety related design data.

The system can include computer instructions to import additional documentation with the operational data and the report. The additional documentation can include design records, procurement records, installation records, test records, maintenance records, and decommissioning records.

As an example of operation of the system, a user can log into a browser-based application that retrieves data over the network and/or locally on the user's own machine. Several options can be presented to the user for interfacing with the data, such as data at a chemical plant for which the user works. The user might want to see data relevant to safety systems and related equipment that are designed to mitigate operational hazards. For example, the user might want to ascertain whether or not maintenance is being performed on the safety related equipment in accordance with the equipment's original design parameters. The user can use the interface described herein because various kinds of data on the safety systems can originate from several discrete systems across many discipline areas in the facility. The processor and database application described herein can contain tools and data libraries that can tie all of these independent systems together in one place and on one interface.

The user can view a list of all units in the plant. For each unit, categories of safety systems can be presented to the user. The user can first be interested in data for one particular unit, such as “Unit Three for Instrumented Alarms”. The user can choose a report to view, such as a “Hazard Study Results” for “Unit Three for Instrumented Alarms”. The user can browse through this report and data and view a list of protection devices listed for the unit. The user can also view one or more visual red/green/yellow indicators or traffic alarms showing that certain assets or protection devices are missing maintenance procedures or are otherwise not in compliance. This visual alarm can prompt the user to action resulting in a procedure being created, implemented, and a potential compliance issue resolved.

In an example of operation of the system, the user can cease viewing this report, and now can begin to investigate the maintenance records for a device that the user is already familiar with. The user can enter another area of the application that displays a list of assets and their technical/design data. The application can present to the user that maintenance records exist in an external system related to the device. The user can also view that the specified maintenance interval in the design data matches the actual maintenance interval being followed in three different maintenance systems external to the application. The user, satisfied with this status, can exit the application.

The following is an example of operation of the system by an administrator.

An administrator can use a restricted code to access a configuration area in the application. In the configuration area, the administrator can check to ensure that data loads from all external systems are being executed as expected. The system can inform the administrator that a new data source exists and needs to be integrated with the application. The administrator can configure the data map for the new data source and associate the new data with existing data in the application. The administrator can specify the location of the new data and initiate a load. As such, the new data can be loaded and associated into the application. With the new data loaded and associated into the application, all application users can see the new data in existing application reports.

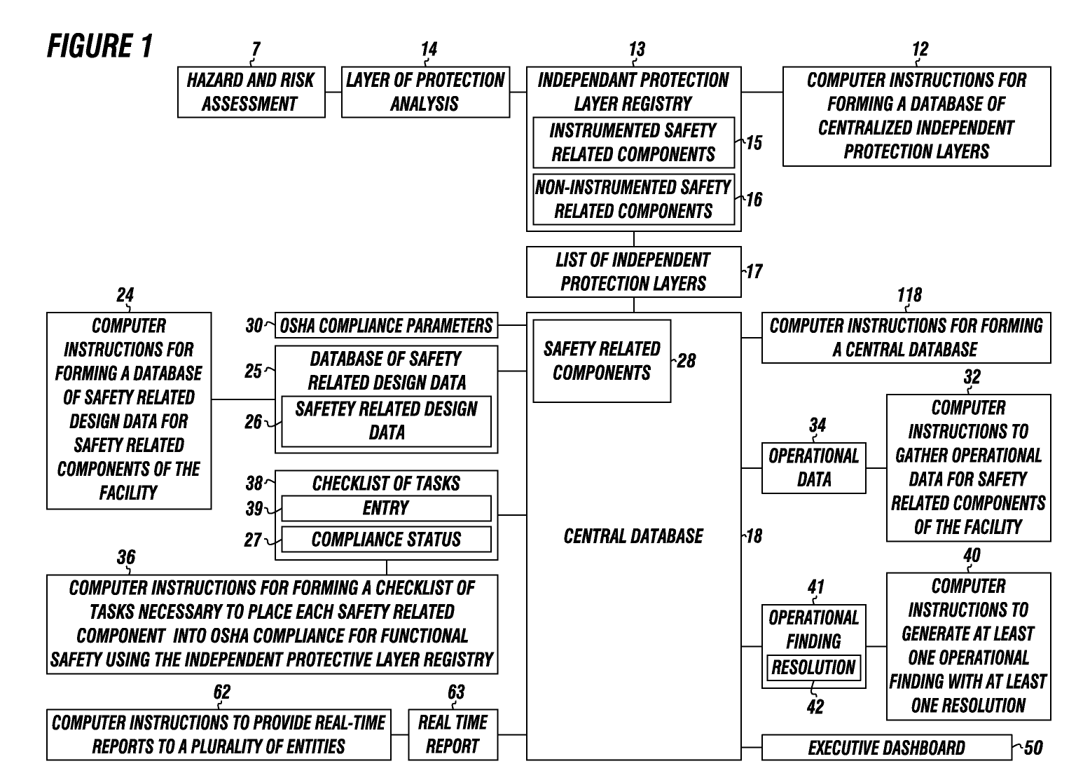

Turning now to FIG. 1, a diagram of the information used in the system is depicted. In operation, a facility can have a hazard and risk assessment 7 performed. The hazard and risk assessment 7 can result in a layer of protection analysis 14 (LOPA). The layer of protection analysis 14 can be used to create an independent protection layer registry 13, which can contain instrumented safety related components 15 and non-instrumented safety related components 16.

In one or more embodiments, the independent protection layer registry 13 can be formed using computer instructions for forming a database of centralized independent protection layers 12.

The independent protection layer registry 13 can be used to form a list of independent protection layers 17 for the facility, such as a particular chemical plant in Corpus Christi, Tex.

The list of independent protection layers 17 can be transmitted to a central database 18, which can be resident in a data storage.

In one or more embodiments, computer instructions for forming a central database 118 can be used to form the central database 18.

The central database 18 can receive OSHA compliance parameters 30, such as from a third party database over a network or by using a link to a website with another database over a network.

The central database 18 can also receive safety related design data 26 from a third party database over a network. For example, the central database 18 can receive the safety related design data 26 from a database of safety related design data 25.

In one or more embodiments, the safety related design data 26 can be formed using computer instructions for forming a database of safety related design data for safety related components of the facility 24.

In operation, when the OSHA compliance parameters 30 and the safety related design data 26 are stored in the central database 18, safety related components 28 can be identified and can also be stored in the central database 18.

Operational data 34 can be imported into the central database 18 through a network.

The operational data 34 can include data from transducers, sensors, and other instrumentation in the facility. In one or more embodiments, the operational data 34 can be gathered using computer instructions to gather operational data for safety related components of the facility 32.

The central database 18 can receive a checklist of tasks 38 having at least one entry 39 for a safety related event. In one or more embodiments, the checklist of tasks 38 can be formed and received by the central database 18 by using computer instructions for forming a checklist of tasks necessary to place each safety related component into OSHA compliance for functional safety using the independent protective layer registry 36. The checklist of tasks 38 can include a compliance status 27.

In one or more embodiments, computer instructions to generate at least one operational finding with at least one resolution 40 can be used to generate the operational finding 41. The operational finding 41 can include at least one resolution 42. The operational finding 41 with the resolution 42 can be imported into the central database 18.

The central database 18 can be used to generate a real-time report 63, such as by using computer instructions to provide real-time reports to a plurality of entities 62. The real-time report 63 can be provided to client devices via a network simultaneously on the real-time status of OSHA compliance.

The central databases 18 can form and transmit an executive dashboard 50 for presentation of data and information from within the central database 18 to users with client devices.

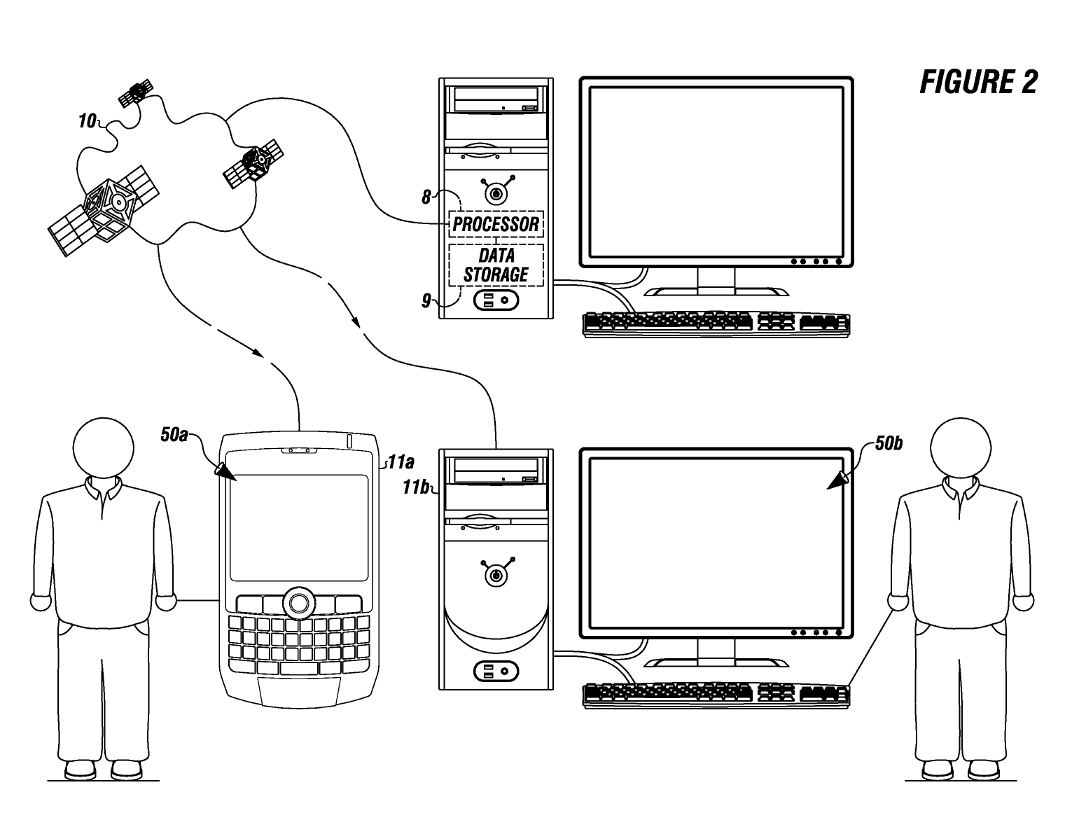

FIG. 2 depicts an embodiment of the system, including a data storage 9 in communication with a processor 8.

The processor 8 can be in communication with client device 11a and client device 11b through a network 10, such as the Internet or another land or satellite based network.

The client devices 11a and 11b can be laptops, cell phones, iPods™, or the like.

Real-time executive dashboards 50a and 50b can be displayed on each client device 11a and 11b. Each executive dashboard 50a and 50b can show compliance information, compliance trend information, and status information in real-time, twenty four hours a day, and seven days a week.

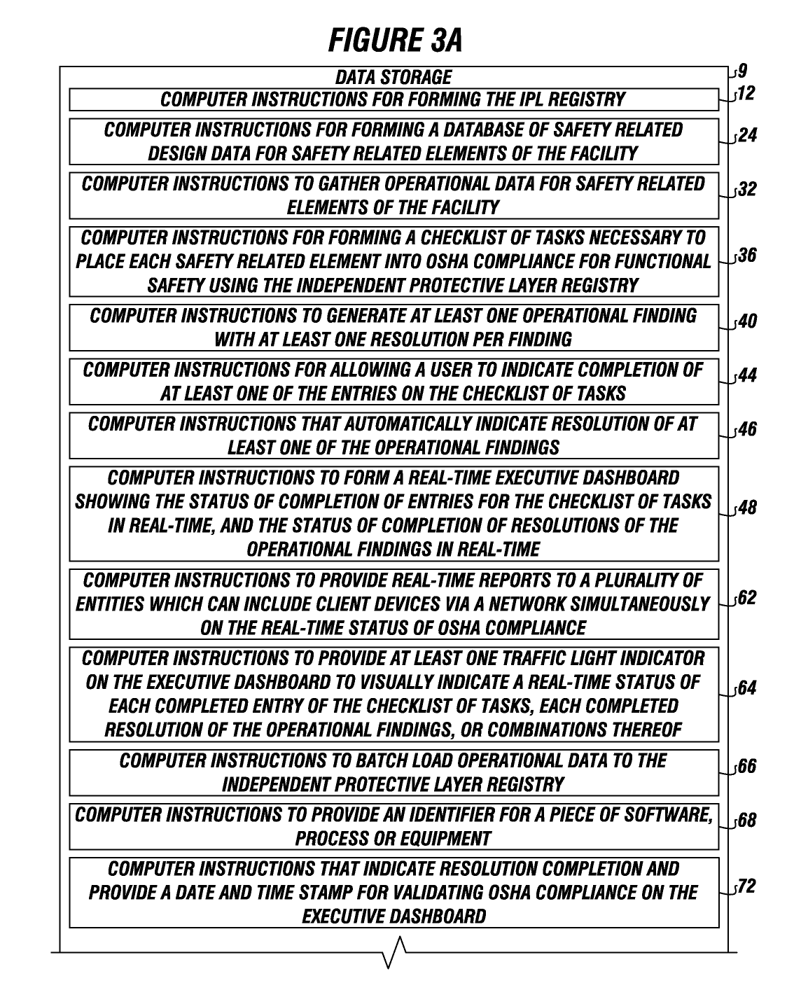

FIG. 3A depicts an embodiment of the data storage 9 with a plurality of computer instructions stored thereon.

The data storage 9 can include: computer instructions for forming the IPL registry 12; and computer instructions for forming a database of safety related design data for safety related components of the facility 24.

The data storage 9 can include computer instructions to gather operational data for safety related components of the facility 32; computer instructions for forming a checklist of tasks necessary to place each safety related component into OSHA compliance for functional safety using the independent protective layer registry 36; computer instructions to generate at least one operational finding with at least one resolution per finding 40; computer instructions for allowing a user to indicate completion of at least one of the entries on the checklist of tasks 44; computer instructions that automatically indicate resolution of at least one of the operational findings 46; computer instructions to form a real-time dashboard showing the status of completion of entries for the checklist of tasks in real-time and the status of completion of resolutions of the operational findings in real-time 48; computer instructions to provide real-time reports to a plurality of entities which can include client devices via a network simultaneously on the real-time status of OSHA compliance 62; and computer instructions to provide at least one traffic light indicator on the executive dashboard to visually indicate a real time-status of each completed entry of the checklist of tasks, each completed resolution of the operational findings, or combinations thereof 64.

The data storage can include computer instructions to batch load operational data to the independent protective layer registry 66.

The data storage can include computer instructions to provide an identifier for a piece of software, process or equipment 68.

The data storage 9 can include computer instructions that indicate resolution completion and provide a date and time stamp for validating OSHA compliance on the executive dashboard 72.

FIG. 3B depicts an embodiment of the data storage 9, including: computer instructions for providing an indicator when each equipment, process, or software that fails to meet a design parameter, providing a reason for failure, providing a corrective action, and providing an identifier for an identified piece of software, process or piece of equipment 73.

The data storage 9 can include computer instructions to present the executive dashboard on multiple client devices simultaneously in multiple formats allowing for different depictions of the results of the compliance viewing 74.

The data storage 9 can also include: computer instructions for presenting on each executive dashboard an indicator for “compliance” 75; computer instructions for presenting on each executive dashboard an indicator for “noncompliance” 76; computer instructions for presenting on each executive dashboard an indicator for “indeterminate” 77; computer instructions for presenting on each executive dashboard a time dated status chart showing compliance entry on the checklist of tasks 110; computer instructions for presenting on each executive dashboard OSHA compliance trends by independent protective layer for each user or viewer designated equipment, software, processes, or combinations thereof, and presenting OSHA compliance trends by each user or viewer designated piece of equipment, software, process or combinations thereof 112.

The data storage 9 can include computer instructions for presenting on each executive dashboard OSHA verifications that design parameters of the facility match designated equipment, software and processes installed and operating in the facility 114; computer instructions that immediately show completion of at least one resolution on the executive dashboard when an administrator loads post resolution operation data and compares the post resolution operational data to the safety related design data 116; computer instructions to form the central database 118; and computer instructions for allowing users to securely log into personal accounts 119.

Also, real-time reports 67 can be stored in the data storage 9.

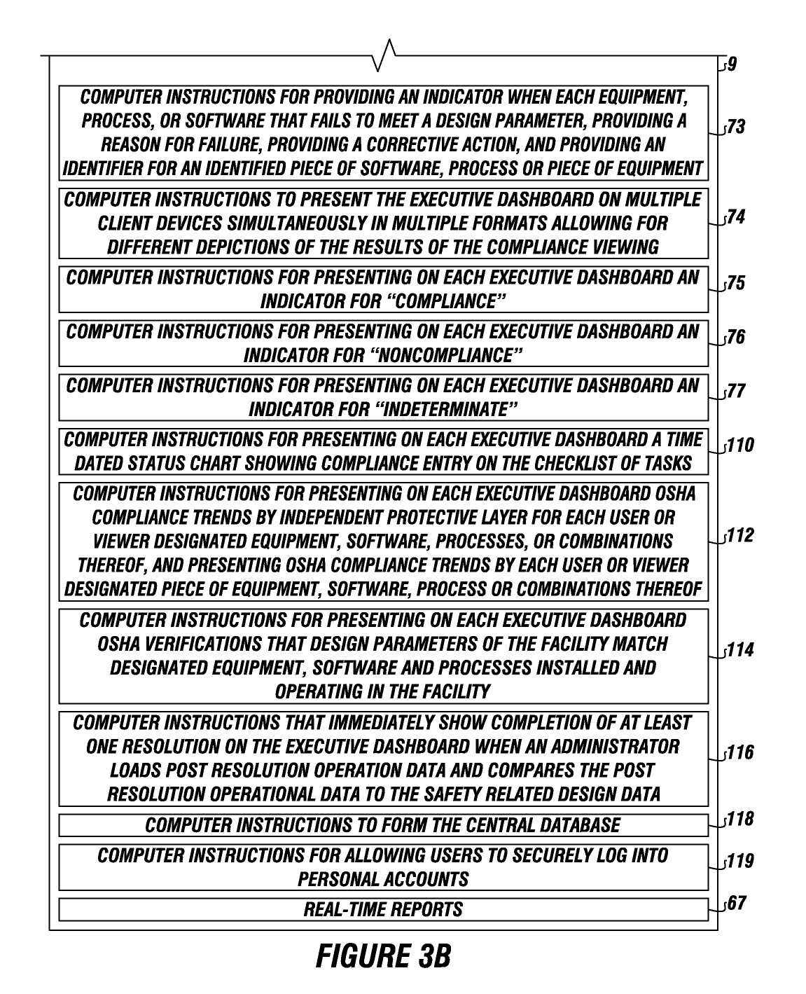

FIG. 4 depicts a diagram of an executive dashboard 50 showing the status of entries for a checklist of tasks 52.

The status of entries for the checklist of tasks 52 can include a percent completion of the entries of the checklist of tasks 54 and a rate associated with the completion of the entries for the checklist of tasks over time for each piece of equipment, software or process of the facility 56.

Also presented in the executive dashboard 50 is a status of completion of resolutions of the operational findings 57, including: a percent completion of the resolutions for the operational findings 58 and a rate associated with completion of the resolutions for the operational findings over time for each piece of equipment, software, or process of the facility 60.

A traffic light indicator can be disposed adjacent each entry in the status of entries for the checklist of tasks 52. For example, a first traffic light indicator 65a can be next to the percent completion of the entries of the checklist of tasks 54, and a second traffic light indicator 65b can be next to the rate associated with the completion of the entries for the checklist of tasks over time for each piece of equipment, software or process of the facility 56.

A traffic light indicator can be disposed adjacent each entry in the status of completion of resolutions of the operational findings 57. For example, a third traffic light indicator 65c can be next to the resolution for the operational finding 58, and a forth traffic light indicator 65d can be next to the rate associated with completion of the resolutions for the operational findings over time 60.

A first indicator 71a, second indicator 71b, third indicator 71c, and fourth indicator 71d can be presented adjacent each of the traffic light indicators for showing when a piece of equipment, process or software fails to meet a design parameter.

The executive dashboard 50 can also show a time and date indicator for each piece of information presented therein. For example, a time and date indicator 111 can be presented with the second indicator 71b.

The executive dashboard 50 can present compliance trends of equipment 113a, compliance trends of software 113b, compliance trends of process 113c along with verification 115a, verification 115b, and verification 115c of operational findings.

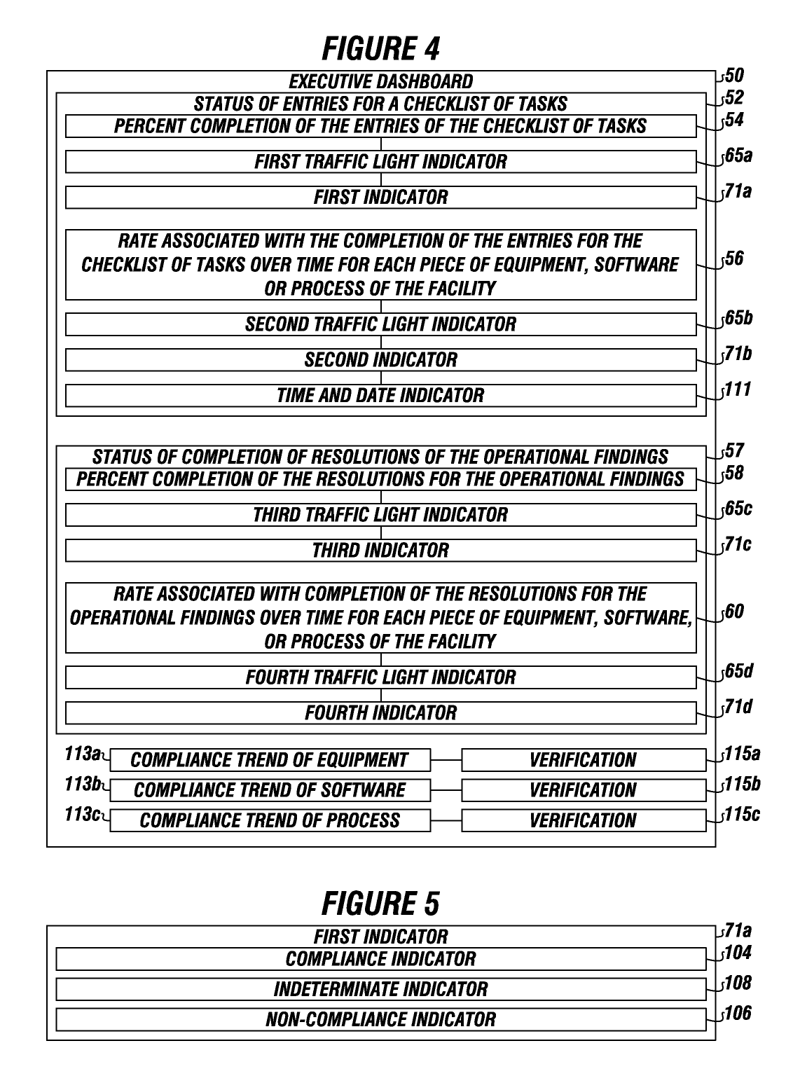

FIG. 5 is a detail of the first indicator 71a, which can include a compliance indicator 104, a noncompliance indicator 106, and an indeterminate indicator 108.

While these embodiments have been described with emphasis on the embodiments, it should be understood that within the scope of the appended claims, the embodiments might be practiced other than as specifically described herein.

What is claimed is:

1. A system for accelerating and validating OSHA compliance for safety system lifecycle management to achieve functional safety at a facility as required in a hazard and risk assessment for the facility by providing monitoring, tracking of remediation, validation of remediation, and reporting for auditing requirements all steps related to achieving compliance, the system comprising:
a. a processor in communication with a data storage and a network;
b. at least one client device in communication with the network,
c. a plurality of computer instructions in the data storage accessible to each client device through the network, and wherein the plurality of computer instructions comprise:
(i) computer instructions to extract independent protective layers from a layer of protection analysis for a portion of the facility which has a hazard and risk assessment for the portion of the facility;
(ii) computer instructions to form an IPL Registry in a central database, wherein the IPL Registry comprises:
1.extracted independent protective layers;
2. multiple layers of security, wherein each layer of security comprises a unique access priority code for controlled management of data in the IPL Registry;
3. instrumented safety related components for at least a portion of the facility;
4. non-instrumented safety related components for at least a portion of the facility; or
5. combinations thereof;
(iii) computer instructions to form a database of safety related design data for instrumented and non-instrumented safety related components of the facility, wherein the database of safety related design data comprises:
design parameters for each piece of equipment, process, software or combinations thereof or for at least a portion of the facility, and wherein the design parameters meet at least one of the extracted independent protective layers required for OSHA compliance for functional safety;
(iv) computer instructions to gather operational data for the safety related components of the facility;
(v) computer instructions for forming at least one checklist of tasks for a plurality of users, wherein each checklist of tasks is assigned to at least one component of an independent protection layer in the IPL Registry, and the checklist of tasks comprises: at least one entry to verify that the safety related components are in OSHA compliance for functional safety, thereby accelerating validation by at least ten percent and achieving compliance systematically;
(vi) computer instructions to compare in real-time the safety related design data to the operational data for each of the safety related components of the IPL of the facility to validate operational compliance of the safety related components and if one of the components is not in compliance, forming at least one operational finding requiring resolution;
(vii) computer instructions to allow a user to indicate a compliance status for the independent protection layers for at least one of the entries on the checklist of tasks;
(viii) computer instructions to automatically indicate resolution of at least one of the operational findings;
(ix) computer instructions to form a real-time dashboard showing a status of compliance of the entries on the checklist of tasks and a status of completion of resolutions of the operational findings in real-time, wherein the real-time dashboard displays:
1. a percent completion of the entries for the checklist of tasks;
2. a rate associated with completing the entries over time for each piece of equipment, process, software, or combinations thereof, for the facility;
3. a percent completion of resolutions in the operational findings;
4. a rate associated with a time to complete the resolutions for each piece of equipment, processor, software, or combinations thereof for the facility;
(x) computer instructions to provide real-time reports for auditing compliance for the components;
(xi) computer instructions to provide at least one traffic light indicator on the real-time dashboard to visually indicate a real-time status of: completion for each entries on the checklist of tasks, completion of resolution of operational findings, or combinations thereof, wherein the system accelerates and validates OSHA compliance for safety system lifecycle management to achieve functional safety at the facility in compliance with Occupational Safety and Health Assessment rule 29 CFR 1910.119 effective date of Mar. 7, 1996 by providing monitoring, tracking of remediation, validation of remediation, and reporting for auditing.

2. The system of claim 1, wherein the checklist of tasks identifies:
a. a specific purpose;
b. an assessment of independency between extracted identified independent protective layers;
c. a diversity between the extracted identified independent protective layers;
d. a physical separation between the extracted identified independent protective layers;
e. a common cause failure between the extracted identified independent protective layers; and
f. a common cause failure between the extracted identified independent protective layers and a basic process control system.

3. The system of claim 1, wherein the checklist of tasks comprises a task to:
a. verify operator training on each piece of equipment, processes, software, or combinations thereof;
b. verify availability of test procedures on operations of each piece of equipment, processes, software, or combinations thereof;
c. verify scheduled testing has been performed on operations of each piece of equipment, processes, software, or combinations thereof;
d. verify each piece of equipment, processes, software, or combinations thereof are configured to identify a fail limit;
e. verify each piece of equipment, processes, software, or combinations thereof are configured to provide an alarm when each piece of equipment, processes, software, or combinations thereof exceeds the fail limits;
f. verify an identify of each piece of equipment, processes, software, or combinations thereof, as “fail-safe” or not “fail-safe”; and
g. use the traffic light indicator to present a compliance or non-compliance status for each verified piece of equipment, processes, software, test procedure, operator training, or combinations thereof, thereby enabling very fast recognition of compliance status by a user.

4. The system of claim 1, wherein the operational data comprises data from at least one original equipment manufacture, an operations database for the facility, data from a testing facility, data from an enterprise server, data from a linked website via a network, data from a linked database via a network, or combinations thereof.

5. The system of claim 1, wherein an identified independent protective layer comprises one or more pieces of equipment, software, processes, or combinations thereof; that reduce a risk of a hazard identified in the hazard and risk assessment by controlling, preventing, or mitigating or combinations thereof, the identified risk of hazard.

6. The system of claim 1, wherein the databases of safety related design data comprises:
a. components of a safety requirement specification for OSHA compliance;
b. a description of all safety instrumented functions in the facility subject to the hazard and risk assessment;
c. a definition of a safe state for each piece of equipment, the software, the facility, or combinations thereof;
d. a requirement for proof test intervals for each piece of equipment, software, the facility, or combinations thereof;
e. response time requirements to bring each process, piece of equipment, software, the facility, or combinations thereof to a safe state;
f a description of process measurements and trip points for each process of the facility;
g. a logic solver type for the piece of equipment, software, the facility, or combinations thereof;
h. a programmable electronic system for control, protection, or monitoring of each piece of equipment, process, facility, or combinations thereof; or i. combinations thereof.

7. The system of claim 1, wherein the operational data comprises instrument equipment design, operation and maintenance data, maintenance records, test records, equipment specifications, equipment configurations, software configurations, equipment information, software information and combinations thereof.

8. The system of claim 1, wherein the processor can be within a web server connected to the network, a server maintained by a service provider, or the client device connected to the network.

9. The system of claim 1, further comprising computer instructions to batch load independent protective layers data to the database for forming real time reports.

10. The system of claim 1, wherein the facility is a manufacturing facility, a chemical facility, a refinery, an offshore drilling platform, or an oil and gas pipeline.

11. The system of claim 10, wherein real time report comprises:
a. a location of a specific independent protective layers;
b. maintenance records of a specific independent protective layers;
c. proof of functional tests on a specific independent protective layers;
d. additional user designated independent protective layers registry information,
e. an indication of non-compliance;
f an indication status of indeterminate for compliance;
g. a time dated status chart showing a compliance entry on the checklist of tasks;
h. OSHA compliance trends by independent protective layers;
i. OSHA compliance trends by piece of equipment, software, processes, or combinations thereof, or the facility; and
j. verifications that design parameters of the facility match pieces of equipment, software, processes, and combinations thereof, which are installed and operating in the facility.

12. The system of claim 1, wherein the traffic light indicator is a colored alarm, an email, a text message, a gauge, a graphical visual component showing a rate of change or percentage of completion of entries or resolutions, an audio indicator, or combinations thereof.

13. The system of claim 1, wherein in at least one independent protective layer of the IPL Registry comprises an automated action comprising a safety instrumented control system to perform an automatic shut down of one of the pieces of equipment, processes, software, combinations; thereof, or the entire facility.

14. The system of claim 1, wherein the at least one independent protective layer comprises a basic mechanical device providing safety in the facility.

15. The system of claim 1, wherein the at least one independent protective layer comprises a process alarm with operator corrective action for an instrumented device that provides a notification by email, text, visual signal, audio signal, or combinations thereof, to an operator for intervention in a prescribed time period.

16. The system of claim 1, wherein the at least one independent protective layer comprises a basic process control system, wherein the basic process control system is a level control, a temperature control, a pressure control, a high level safety interlock or combinations thereof.

17. The system of claim 1, further comprising computer instructions that indicate resolution completion and provide a date and time stamp for validating OSHA compliance on the real time dashboard.

18. The system of claim 1, wherein the network is a satellite network, a cellular network, the Internet™, a local area network, another IP packet delivery system or combinations thereof.

19. The system of claim 1, wherein the client device is a cellular phone, processor with a web browser, a laptop, or other device with a processor and ability to connect to the network.

20. The system of claim 1, further comprising computer instructions for the operational finding that provide an indicator when each equipment, process, or software fails to meet design parameters, a reason for failure, a corrective action, and an identifier of the software, process or equipment.

21. The system of claim 1, wherein the computer instructions to form the real time dashboard include computer instructions to present the dashboard on multiple client devices simultaneously in multiple formats, and further include on each dashboard:
a. an indication for compliance;
b. an indications for non-compliance;
c. an indication for indeterminate for compliance;
d. a time dated status chart showing a compliance entry on the checklist of tasks;
e. OSHA compliance trends by IPL;
f. OSHA compliance trends by designated equipment, software, processes, or combinations thereof; or the entire facility; and
g. verifications that the design parameters of the facility match equipment, software, and processes and combinations thereof, installed and operating in the facility.

22. The system of claim 21, wherein real time dashboard further comprises:
a. a location of a specific independent protective layer;
b. maintenance records of a specific independent protective layers;
c. proof of functional tests on a specific independent protective layers; and
d. additional user designated IPL registry information.

23. The system of claim 1 wherein the computer instructions that automatically indicate resolution of at least one of the operational findings further comprise computer instructions that immediately show completion of the resolution on the dashboard when an administrator loads post resolution operation data to a database and uses computer instructions in the data storage to compare the post resolution operational data to the safety related design data.

24. The system of claim 1, wherein the real time reports on the real time status of OSHA compliance are transmitted to a member of the group comprising: facility employees, agents, contractors, vendors, investors, environmental agencies and combinations thereof.
